(19) United States
(12) Patent Application Publication
(10) Pub. No.: US 2018/0260902 A1
(43) Pub. Date: Sep. 13, 2018

(54) SYSTEM AND METHOD FOR DETERMINING AN OPTIMAL STOPPING TIME

(71) Applicant: Michael John Curran, New York, NY (US)

(72) Inventor: Michael John Curran, New York, NY (US)

(21) Appl. No.: 15/911,471

(22) Filed: Mar. 5, 2018

Related U.S. Application Data
(60) Provisional application No. 62/470,228, filed on Mar. 11, 2017.

(51) Int. Cl. G06Q 40/06; G06Q 40/04; G06Q 10/04

(52) U.S. Cl. CPC G06Q 40/06; G06Q 10/04; G06Q 40/04

(57) ABSTRACT

A system is disclosed. The system has an optimal stopping time determination module, comprising computer-executable code stored in non-volatile memory, a processor, and a user interface. The optimal stopping time determination module, the processor, and the user interface are configured to solve an optimal stopping problem using a backward-looking procedure, and prescribe a hedge as part of solving the optimal stopping problem using the backward-looking procedure.

### RELATED APPLICATIONS

This application claims the benefit of U.S. Provisional Patent Application Ser. No. 62/470,228 filed Mar. 11, 2017, which is hereby incorporated by reference in its entirety.

### TECHNICAL FIELD

The present disclosure is directed to a system and method for determining an optimal stopping time, and more particularly, to a system and method for determining an optimal stopping time regarding for example taking an action (e.g., exercising an option).

### BACKGROUND OF THE DISCLOSURE

Stochastic control problems, such as those of optimal stopping, are particularly challenging when multiple stochastic variables are present. In this case the standard approach of dynamic programming may lead to prohibitively large computation times. Accordingly, a need in the art exists to overcome this computational issue.

The exemplary disclosed method, system, and apparatus of the present disclosure is directed to overcoming the shortcoming set forth above and/or other deficiencies in existing technology.

### SUMMARY OF THE INVENTION

In one aspect, the present invention is directed to a system. The system involves a stochastic simulation of relevant variables over a predetermined number of discrete time steps. The system then determines an optimal stopping time for the simulated paths with increasing numbers of remaining time steps. For example, the optimal stopping time for each path is determined when two time steps remain, so that each path will be stopped (e.g., exercised) at either the ultimate or penultimate time point, then when 3 time steps remain, and so on. At each stage in the backwards recursion, the solutions of previous stages are utilized as a starting point and then exercise at the present time point is considered. If exercise is deemed optimal for a particular path, the stopping time for that path is updated. Once this procedure is completed for each stage, the output is directed to a user interface. This output includes a value of the option at a root node (e.g., root node of the paths) as well as exercise decisions for each individual path.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still within the spirit of the disclosure as described herein.

FIG. 1 is a flowchart illustrating an exemplary method, in accordance with at least some exemplary embodiments of the present disclosure;

FIG. 2 is a schematic illustration of an exemplary system, in accordance with at least some exemplary embodiments of the present disclosure;

FIG. 3 is a flowchart illustrating an exemplary method, in accordance with at least some exemplary embodiments of the present disclosure;

FIG. 4 is a schematic illustration of an exemplary computing device, in accordance with at least some exemplary embodiments of the present disclosure; and

FIG. 5 is a schematic illustration of an exemplary network, in accordance with at least some exemplary embodiments of the present disclosure.

### DETAILED DESCRIPTION AND INDUSTRIAL APPLICABILITY

The exemplary disclosed system and method may be any suitable system for determining an optimal time (e.g., optimal stopping time) for taking an action (e.g., exercising an option). For example, the exemplary disclosed system and method may be any suitable system that determines the time of a decision (e.g., the time of some decision associated with an action) that may represent the end or beginning of a process, in which the decision leads to a payoff. For example, the exemplary disclosed system and method may determine an optimal stopping time for exercising an option such as a bermudan-style option (e.g., or any other suitable types of other options that have early exercise features). For example, the exemplary system and method may determine an optimal stopping time for an action that may be exercised at any time before or at a time of maturity (e.g., an expiration date). Also for example, the exemplary system and method may determine an optimal stopping time for an action that may be exercised at a set number of times before or at a time of maturity (e.g., at discretely spaced times). Further for example, the exemplary disclosed system and method may be any suitable system for solving a problem regarding best timing of a decision in a stochastic (e.g., probabilistic) context. For example, the exemplary disclosed system and method may be any suitable system for deciding when to exercise an option, when to buy or sell an asset, when to begin or end a project, and/or when to take an action that is tied to a payoff in any suitable situation.

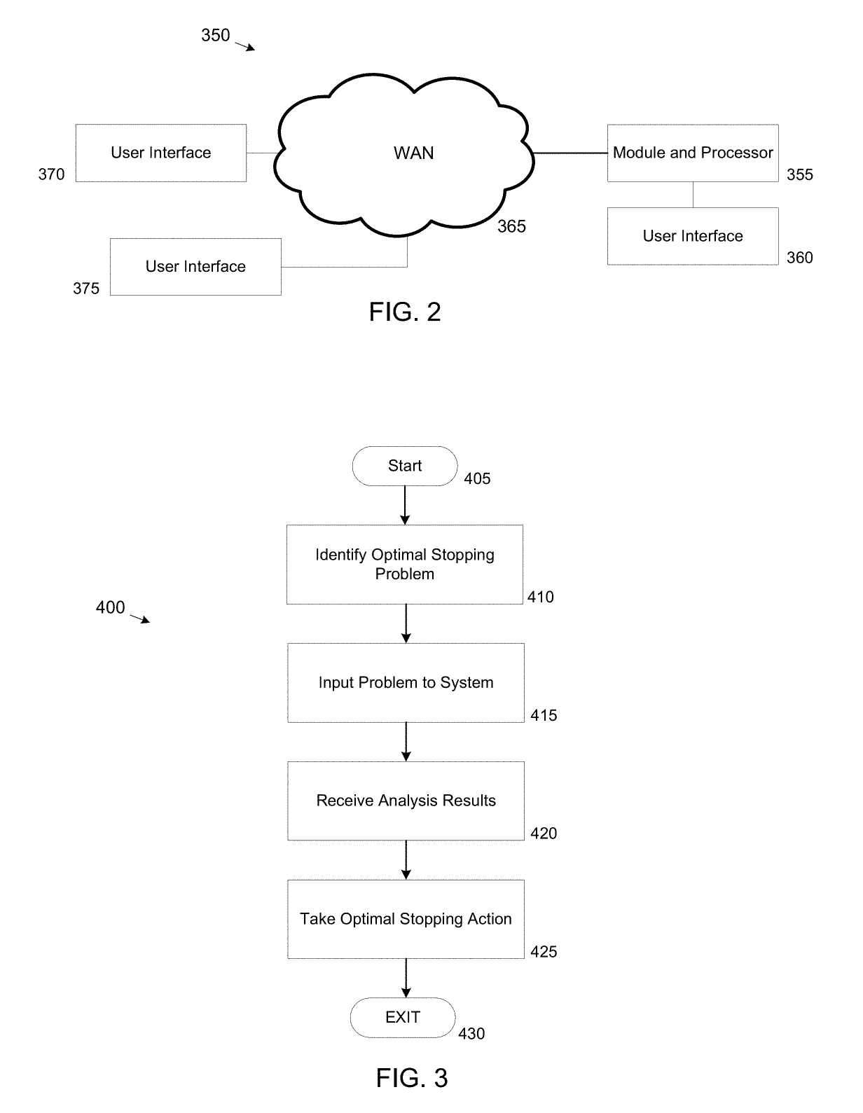

For example, the exemplary disclosed system and method may include an algorithm for solving optimal stopping problems (e.g., involved in bermudan-style options that can be exercised prior to or at an expiration date, e.g., at a discrete set of times prior to the expiration date). For example, the exemplary disclosed system and method may include any suitable type of simulation in which repeated random sampling is used to obtain numerical results. For example, the exemplary system and method may include a simulation that applies a selected or predetermined model (e.g., any model that specifies the stochastic behavior of an instrument or activity) and provides a large set of random trials. For example, the large set of random trials may produce a plausible set of possible future outcomes for an activity. For example, the exemplary system and method may use any suitable model for employing repeated random sampling (e.g., using randomness-based approaches) to obtain numerical results for solving problems. The exemplary algorithms, simulations, and/or processes disclosed herein may for example be performed using exemplary computing and/or networking components similar to those disclosed below regarding FIGS. 2, 3, 4, and 5.

For example, the exemplary disclosed system and method may include a duality-based technique and a backward-looking procedure (e.g., backward recursion and/or backward induction) as disclosed for example below. For example, the duality-based technique may include pitting two objectives against each other, which may be implemented using a backward-looking procedure. For example, a buyer of an option (e.g., of a bermudan-style option) attempting to maximize value by exercising the option at an optimal time (e.g., optimal stopping time) may be pitted against a seller attempting to hedge against risk in an optimal manner. For example, the hedging strategy or effort may include taking a position to balance or offset risk associated with an uncertainty of the exemplary process (e.g., an uncertainty of the exemplary stochastic process) by assuming one or more positions in an opposing investment or effort (e.g., assuming a contrary position in a stock or security, e.g., when the exemplary system and method is a financial system and method). For example, the duality-based technique of the exemplary system and method may set an objective (e.g., problem-solving strategy or effort) supporting a buyer (e.g., a buyer of a bermudan-style option seeking to maximize payout by exercising the option at the optimal time) against a seller (e.g., a seller seeking to optimally hedge against the risk inherent in the stochastic variables). For example, an overarching optimization of the exemplary disclosed system and method may be to maximize a payout for the buyer (e.g., the actor that holds an option). For example, the hedges of the seller may be antagonistic to the goal of the buyer (e.g., as part of a duality-based procedure), but the hedges may also force a foresight-free exercise decision from the buyer (e.g., by preventing the buyer from exploiting foresight to unrealistically “see the future” within the simulation). For example, the exemplary system and method may include nesting the buyer's and seller's efforts at each stage, thus jointly determining the optimal exercise strategy (e.g., backward recursion and/or backward induction) as disclosed for example below.

The opposing buyer and seller aspects are examples of the exemplary disclosed system and method. For example, the exemplary system and method may include any analytical and/or stochastic framework for determining an optimal timing of a decision (e.g., a decision regarding an action) in a stochastic context.

The exemplary system and method may include any suitable randomly-determined processes such as a process including a random process and/or sequence of distributions. For example, the exemplary system and method may include one or more stochastic processes.

For example, the exemplary system and method may include the following exemplary processes and algorithms. For example, at each stage in a backward recursion, two optimization problems may be solved. The first optimization problem may compute the value of a two-step option that allows exercise at two time steps from the present time, and the second optimization problem uses this solution in determining a value of the option having potential early exercise points that are from the present time onward. For example, {Xₛ}^{T}ₛ₋₀ may be a d-dimensional stochastic process and P_{t,t}=f(Xₜ) may be a payoff process with f: R^{d}→R. Also, european values at time t with maturity s≥t may be denoted by P_{t,s}=Eₜ(P_{s,s}) and bermudan values at time t with a set of allowable exercise times (t+1, u) may be denoted by P_{t,(t+1,u}) where u≥t+1 and the range (t,s) is defined} as {t, t+1, t+2, . . . s}. The exemplary system and method may solve the following optimal stopping problem: P_{0,(1,T)}=E₀[max P_{τ,τ}] for a stopping time τ ∈(1, T).

For example, the exemplary disclosed system and method may utilize both a duality-based problem-solving strategy (e.g., provided by a computer-implemented algorithm as disclosed below) and a backward-looking procedure (e.g., provided by a computer-implemented algorithm as disclosed below). For example as disclosed herein, at each stage in backward recursion and/or backward induction techniques illustrated in the exemplary equations and algorithm processes below, two optimization problems may be solved. These optimizations may provide a link between a previously calculated solution (e.g., which determines the values P_{t+1,(t+1,T)}) and a new solution that calculates values P_{t,(t,T)}. For example, the optimization problems may involve rolling over relatively simple instruments such as, e.g., relatively simple securities or stocks (for example, when the exemplary system and method is applied in the financial modeling field).

For example for the sake of clarity, in describing the exemplary processes and algorithms of the exemplary disclosed system and method, no distinction will be made between population (e.g., exact) values and sample estimates (for example those arising from the finite sample embodied in the simulation paths). The exemplary processes and/or algorithms may include N simulated paths as illustrated below in exemplary Equation 1:

{Xₜⁱ:i=1,2, . . . N,t=1,2, . . . T} (Eqn 1)

For example, the exemplary processes and/or algorithms may include N simulated paths of a process {Xt} and associated payoffs as illustrated below in exemplary Equation 2:

{P_{t,t}ⁱ:i=1,2, . . . N,t=1,2, . . . T} (Eqn 2)

Further for example, the exemplary processes and/or algorithms may include a method to calculate european values as illustrated below in exemplary Equations 3 and 4:

P_{t,t+1}ⁱ=Eₜ(P_{t+1,t+1}ⁱ) (Eqn 3)

P_{t,t+2}ⁱ=Eₜ(P_{t+2,t+2}ⁱ) (Eqn 4)

Further for example, the exemplary processes and/or algorithms may include a process to define an exercise indicator for use in the exemplary system and method as illustrated below in exemplary Equation 5. For example regarding Iⁱᵢₙᵢₜ, the “init” subscript may refer to the initial exercise decisions at one step back from maturity (e.g., the exercise decisions at the last time step before maturity):

Iᵢₙᵢₜⁱ=(P_{T-1,T-1}ⁱ,≥P_{T-1,T}ⁱ) (Eqn 5)

Also for example, an exemplary process and/or algorithm may include processes for performing backward-looking procedure (e.g., backward recursion and/or backward induction). Also for example, the exemplary process and/or algorithm may include an approach that progresses backwards in time from an end of a problem (e.g., reasons backwards in time) to calculate or obtain optimal actions (e.g., a combination or sequence of actions). For example, the exemplary process and/or algorithm may initially determine an action to be taken in any situation at a final or last time a decision or choice may be made (e.g., when the exemplary system and method is a financial system and method, the final or last time a decision or choice may be made may be a time at which the right to exercise an option expires). Further for example, the exemplary process and/or algorithm may use the calculations and data determined at the final or last time to determine what action to take in any situation at a penultimate or second-to-last time that a decision or choice may be made (e.g., when the exemplary system and method is a financial system and method, the penultimate or second-to-last time a decision or choice may be made may be a last discrete time to exercise a bermudan-style option prior to the expiration of the bermudan-style option). Further for example, the exemplary process and/or algorithm may similarly continue backwards (in succession moving backward in time) to each earlier time a decision or choice may be made until an action to be taken has been determined in any situation at every point in time for making a decision or choice. For example, the exemplary processes and/or algorithms may include a process for performing a backward-looking procedure (e.g., backward recursion and/or backward induction) at exercise times initialized as illustrated below in exemplary Equation 6:

T_{T-1}ⁱ=Iᵢₙᵢₜⁱ(T−1)+(1−Iᵢₙᵢₜⁱ)T (Eqn 6)

Here, the τ subscript, say s, refers to the exercise time where the exercise set is (s,T).

More generally, for example, the exemplary processes and/or algorithms may solve the problem (e.g., optimal stopping problem) back to time t+1. For example, the exemplary process and/or algorithm may make τⁱₜ₊₁ the next stopping time (e.g., current next stopping time) for path i (e.g., for exercise set (t+1, T)). For example, the exemplary process and/or algorithm may leave τⁱₜ₊₁ as the exercise time or, if exercise is indicated, replace the current exercise time with t.

Further for example, the exemplary processes and/or algorithms may solve the exemplary problem (e.g., the exemplary optimal stopping problem) from time t to time t+2. For example, the exemplary processes and/or algorithms may determine estimates for Pⁱ_{t,(t+1,t+2)} using the exemplary techniques disclosed for example herein. For example, the exemplary processes and/or algorithms may immediately determine the exercise decisions at time t+1 as a simple comparison between the current payoff and the one-step european for each path as disclosed above. For example, set:

Vₜ₊₁ⁱ=max(P_{t+1,t+1}ⁱ,P_{t+1,t+2}ⁱ) (Eqn 7)

M₁ⁱ=P_{t,t+1}ⁱ−P_{t+1,t+1}ⁱ (Eqn 8)

M₂ⁱ=P_{t,t+2}ⁱ−P_{t+1,t+2}ⁱ (Eqn 9)

For example, if an exercise of an action is optimal at time t+1, then the first hedge (one-step european) may cover the liability (e.g., when the exemplary system and method is a financial system and method, it may be optimal to exercise an option at time t+1 in this case). Also for example, if continuation is optimal at time t+1, then the second hedge (two-step european) may cover the liability (e.g., when the exemplary system and method is a financial system and method, it may not be optimal to exercise an option at time t+1 in this case). For example, set:

Iₜⁱ=(P_{t,t+1}ⁱ≥P_{t,t+2}ⁱ) (Eqn 10)

Next, solve the following optimization problem:

$$( {λ}_{1}^{*} , {λ}_{2}^{*} , {λ}_{3}^{*} ) = argmin \{ {\sum }_{i = 1}^{N} max [ {P}_{t , t}^{i} , {V}_{t + 1}^{i} + {λ}_{1} {M}_{1}^{i} + {λ}_{2} {M}_{2}^{i} + {λ}_{3} {I}_{t}^{i} ( {M}_{1}^{i} - {M}_{2}^{i} ) ] \} \qquad ( Eqn 11 )$$

For example, the exemplary processes and/or algorithms may solve the exemplary problem (e.g., the exemplary optimal stopping problem) as a minimax problem (e.g., including a duality-based approach as disclosed for example above). For example, the optimization problem may be solved by jointly resolving the conflicting interests of the buyer and the seller. The buyer's problem-solving strategy or effort may be nested inside a minimum whose arguments may be determined by the seller's problem-solving strategy or effort (e.g., the seller seeking to optimally hedge against risk involved with the strategy or effort of the buyer). This exemplary duality-based nesting approach may yield accurate continuation values (e.g., values as disclosed for example above for determining which action to take at a given time). For example, an exemplary process and/or algorithm may include a first Lagrangian term corresponding to hedging (e.g., as part of the seller's strategy or effort) with one-step europeans, a second Lagrangian term corresponding to hedging (e.g., as part of the seller's strategy or effort) with two-step europeans, and a third Lagrangian term corresponding to hedging with a current (time t) maximum european. Equation 12 provides continuation values resulting from the optimization illustrated in Equation 11:

P_{t,(t+1,t+2)}ⁱ=Vₜ₊₁ⁱ+λ₁*M₁ⁱ+λ₂*M₂ⁱ+λ₃*Iₜⁱ(M₁ⁱ−M₂ⁱ) (Eqn 12)

Further for example, the exemplary processes and/or algorithms may solve the optimization problem provided in Equation 13 using terms as defined in Equations 14, 15, and 16, as illustrated below in exemplary Equations 13-16:

$$( {μ}_{1}^{*} , {μ}_{2}^{*} , {μ}_{3}^{*} ) = argmin \{ {\sum }_{i = 1}^{N} max [ {P}_{t , t}^{i} , {P}_{{τ}_{t + 1}^{i} , {τ}_{t + 1}^{i}}^{i} + {μ}_{1} {N}_{1}^{i} + {μ}_{2} {N}_{2}^{i} + {μ}_{3} {N}_{3}^{i} ] \} \qquad ( Eqn 13 )$$

where,

$$\begin{matrix}{N}_{1}^{i} = {\sum }_{s = t}^{{τ}_{t + 1}^{i} - 1} ( {P}_{s , s + 1}^{i} - {P}_{s + 1 , s + 1}^{i} ) & ( Eqn 14 ) \\ {N}_{2}^{i} = {\sum }_{s = t}^{{τ}_{t + 1}^{i} - 1} ( {P}_{s , s + 2}^{i} - {P}_{s + 1 , s + 2}^{i} ) & ( Eqn 15 ) \\ {N}_{3}^{i} = {\sum }_{s = t}^{{τ}_{t + 1}^{i} - 1} ( {P}_{s , ( s + 1 , s + 2 )}^{i} - {V}_{t + 1}^{i} ) & ( Eqn 16 )\end{matrix}$$

Further for example, the exemplary processes and/or algorithms may include imposing conditions on the duality-based and/or backward-looking procedures. For example, the exemplary system and method may impose that the mean hedging cost is the same irrespective of whether the seller hedges by rolling over, at every time step, one-step europeans, two-step europeans, and two-step bermudans. This condition being imposed may provide for the seller being able to both afford to deliver a payoff (e.g., in the case of the exemplary system and method being a financial system and method, the payoff may be an amount to be paid to close the position of a borrowed security or any other suitable borrowed instruments) at any time step and afford to rollover the one-step european should the buyer choose to continue at that time (e.g., based on the decision at a given time step to exercise an action or not to exercise an action and to continue). For example, the exemplary processes and/or algorithms may accordingly include a process for use in the exemplary system and method as illustrated below in exemplary Equations 17 and 18 (e.g., in which Equation 17 may be solved and exercise times may be updated in Equation 18):

CVₜⁱ=P_{τ}_{₊₁}_{ⁱ}_{,τ}_{ₜ₊}_{ⁱ}ⁱ+μ₁*Nᵢⁱ+μ₂*N₂ⁱ+μ₃*N₃ⁱ∀i (Eqn 17)

if P_{t,t}ⁱ>CVₜⁱ set τₜⁱ=t, otherwise, τₜⁱ=τₜ₊₁ⁱ (Eqn 18)

For example, the exemplary disclosed system and method may include an optimal stopping time determination module, comprising computer-executable code stored in non-volatile memory, a processor, and a user interface (e.g., as disclosed below regarding FIGS. 2, 4, and 5). The optimal stopping time determination module, the processor, and the user interface may be configured to solve an optimal stopping problem using a backward-looking procedure, and prescribe a hedge as part of solving the optimal stopping problem using the backward-looking procedure. For example, prescribing the hedge may include imposing a zero conditional mean of error. Further for example, solving the optimal stopping problem using the backward-looking procedure may include rolling over a one-step european, a two-step european, and a two-step bermudan, wherein the one-step european, the two-step european, and the two-step bermudan may be rolled over at each of a plurality of time steps of the simulated paths of a stochastic simulation. Also for example, solving the optimal stopping problem may include determining an optimal time of stopping, in which stopping may be one of buying or selling an asset or starting or ending a project or activity. Also for example, solving the optimal stopping problem using the backward-looking procedure may include using a stochastic simulation of a plurality of variables over a predetermined number of discrete time steps. Further for example, solving the optimal stopping problem using the backward-looking procedure may include determining the optimal stopping time for the simulated paths of the stochastic simulation with increasing numbers of remaining time steps.

For example, a method for determining an optimal stopping time may include providing a stochastic simulation of a plurality of variables over a predetermined number of time steps of each of the simulated paths of the stochastic simulation. The method may also include solving an optimal stopping problem using backward recursion for each of the simulated paths, and imposing constraints on two optimization problems solved at each stage in the backward recursion. Also for example, the method may include determining an optimal stopping time for each of the simulated paths when a penultimate time step and an ultimate time step remain. Further for example, each of the simulated paths may be stopped or exercised at either the penultimate time step or the ultimate time step. Additionally for example, the method may include determining an optimal stopping time for each of the simulated paths when a second-from-final time step, a penultimate time step, and an ultimate time step remain. Further for example, imposing constraints on the two optimization problems solved at each stage in the backward recursion includes imposing three constraints that impose that no excess profit or loss is realized by hedging by a seller

Also for example, each of the simulated paths may be stopped or exercised at one of the second-from-final time step, the penultimate time step, and the ultimate time step. Additionally for example, when exercise is determined as optimal for each of the simulated paths, then a stopping time may be updated for each of the simulated paths. For example, output data for each of the second-from-final time step, the penultimate time step, and the ultimate time step may be transmitted to a user interface. Further for example, locking in the value of the two-step bermudan may include imposing a zero conditional mean of error. Additionally for example, prescribing the hedge may include maintaining a substantially same mean hedging cost.

An exemplary embodiment of the exemplary disclosed system and method is disclosed below, as illustrated in Equations 19, 20, and 21, and Table 1 below. For example, the exemplary disclosed system and method may include an algorithm that solves an optimal stopping problem for a bermudan put option. For example, the exemplary embodiment may involve simulating stock prices (e.g., the exemplary system and method may be a financial system and method). The exemplary disclosed system and method may also include underlying dynamics and/or simulations driven by geometric brownian motion. For example, the exemplary processes and/or algorithms may include processes for defining an underlying price coupled with a discount factor, as illustrated below.

For example as illustrated below, Sⁱₜ may be the underlying price for path i at time t, r may be the risk-free interest rate, σ may be the volatility of the underlying price, h may be the time step between potential exercise times, and zⁱₜ may be standard normal variates. For example, the exemplary system and method may determine values (e.g., present values at time zero) of the payoffs as illustrated below:

$$\begin{matrix}{X}_{t}^{i} = {( {S}_{t}^{i} , {e}^{- rt} )}^{T} & ( Eqn 19 ) \\ {S}_{t}^{i} = {S}_{t - h}^{i} exp ( ( r - \frac{{σ}^{2}}{2} ) h + ( σ \sqrt{h} ) {z}_{t}^{i} ) & ( Eqn 20 ) \\ {P}_{t , t}^{i} = {{e}^{- rt} ( K - {S}_{i}^{i} )}^{+} & ( Eqn 21 )\end{matrix}$$

Table 1 below further illustrates the above exemplary embodiment (e.g., the exemplary embodiment illustrated by Equations 19, 20, and 21). For example, Table 1 includes MATLAB code setting forth the exemplary process and algorithm of the exemplary embodiment. For example as illustrated in Table 1 below, “AmBer.m” may be a main function that calls PathsPayo_sBS2.m, which constructs the simulation paths and computes european values. Also for example as illustrated in Table 1, “DualProb.m” may be called by the MATLAB library function “fminsearch.m”, and “blsprice.m” may be the MATLAB library function that implements the black-scholes formula. Exemplary Table 1 follows below:

TABLE 1
Exemplary MATLAB Process and Code

```
%%%%%%%%%%%%%%%%%%%%%%%%%%%
Function Price = AmBer(S0, r, sigma, T, NumTimePts, NumPaths, K)
%  S0: initial asset price
%  r: risk-free interest rate
%  sigma: volatility
%  T: time to maturity
%  NumTimePts: number of time points
%  NumPaths: number of simulation paths
%  K: strike price
options  =  optimset ( ′ MaxIter ′ , inf , ′ MaxFunEvals ′ . . .
                        , inf ,  ′ Display ′ , ′ off′ );
%  generate paths and compute payoffs
%  and one and two step european values
[PVPutPayoff , PVBS, PVBS2] =  . . .
PathsPayoffsBS2 ( S0 , r , sigma , T, NumTimePts , NumPaths, K) ;
% exerciseindicator at T-1
ExInd = PVPutPayoff ( : , NumTimePts − 1) > PVBS ( : , NumTimePts −
1 ) ;
%  values at T-1
ExVal = ExInd . * PVPutPayoff ( : , NumTimePts − 1) + . . .
                    (1−ExInd ) . * PVPutPayoff ( : , NumTimePts ) ;
% initialize stopping times of full bermudan
tau = ExInd * ( NumTimePts − 1) + (1−ExInd ) * NumTimePts;
% allocaterollover PnL vectors
RolloverPnL1 = zeros (NumPaths, 1);
RolloverPnL2 = zeros (NumPaths, 1);
RolloverPnL3 = zeros (NumPaths, 1);
% initialize rollover PnL vectors -special case one period from
%expiration
RolloverPnL1 = . . .
      (1-ExInd) .* (PVBS(: , NumTimePts-1) - PVPutPayoff(: ,
      NumTimePts));
RolloverPnL2 = RolloverPnL1;
RolloverPnL3 = RolloverPnL1;
for j = NumTimePts − 2 : −1 : 1
%  exercise indicator at time j+1 with maturity j+2
ExInd2 = PVPutPayoff ( : , j +1) > PVBS ( : , j +1 );
%  maximum european indicator
MaxInd2 = PVBS ( : , j) > PVBS2 ( : , j);
%  exercise value of 2-step bermudan
%prior to consideringexerciseat
%  time j and values taken at j+1
ExVal2 = ExInd2 .* PVPutPayoff( : , j +1) + (1−ExInd2 ) . * PVBS
( : , j +1);
% prepare for optimizing 2-step bermudani
% exercise decision at time j
% one step european rollover PnL
M1 = PVBS( : ,j ) PVPutPayoff ( : , j +1 );
% two step european rollover PnL
M2 = PVBS2( : , j ) − PVBS( : , j +1 );
LagrangeTerm = [M1, M2, ( 1 − 2* MaxInd2 ) . * (M1 − M2 ) ] ;
lambdaOld = [0;0;0]; % initialize lagrange multipliers
%  perform optimization determining lagrange multipliers
% for two step bermudan
lambda = . . .
ftminsearch (@(lambda) DualProb (lambda, PVPutPayoff (: , j ) ,
ExVal2 , . . .
  LagrangeTerm , lambdaOld ) , lambdaOld , options ) ;
% continuation values of two step bermudan
CV2 = ExVal2 + LagrangeTerm * lambda ;
% time j exercise indicator
ExInd2New = PVPutPayoff ( : , j ) > CV2;
%  price of two step bermudan
Price = mean(ExInd2New .* PVPutPayoff (:, j) + (1−ExInd2New) .*
CV2 ) ;
% next solve bermudan with exercise set from j to NumTimePts
%  update rollover vectors
RolloverPnL1 = PVBS( : ,j) −PVPutPayoff( : ,j + 1) + RolloverPnL1 ;
RolloverPnL2 = PVBS2( : ,j ) −PVBS( : ,j+1) + RolloverPnL2 ;
RolloverPnL3 = CV2 − ExVal2 + RolloverPnL3 ;
LagrangeTerm = [ RolloverPnL1 , RolloverPnL2 , RolloverPnL3 ] ;
nuOld = [ 0 ; 0 ; 0 ] ;
%  perform optimization determining lagrangemultipliers for full
%  bermudan
nu = fminsearch(@(nu) DualProb (nu, PVPutPayoff ( : , j ) , . . .
                      ExVal , LagrangeTerm , nuOld ) , nuOld ,
                      options ) ;
%  continuation  values of full bermudan
CV = ExVal + LagrangeTerm * nu ;
%  exercise indicator of full bermudan
ExInd = PVPutPayoff ( : , j ) > CV;
%  update exercise values
ExVal = ExInd . * PVPutPayoff ( : , j ) + (1−ExInd ) . * ExVal ;
%  update exercise time
tau = ExInd . * j + (1−ExInd ) . * tau ;
%  update  rollovers
RolloverPnL1 = ExInd .* 0 + (1−ExInd) .* RolloverPnL1 ;
RolloverPnL2 = ExInd .* 0 + (1−ExInd) .* RolloverPnL2 ;
RolloverPnL3 = ExInd .* 0 + (1−ExInd) .* RolloverPnL3 ;
CV = ExInd . * PVPutPayoff ( : , j ) + (1−ExInd ) . * CV;
end
% average continuation  values at time 1
Price = mean(CV) ;
end
%%%%%%%%%%%%%%%%%%%%%%%%%%
function [PVPutPayoff, PVBS, PVBS2 ] = PathsPayoffsBS2 (S0, r, sigma,
                          T, . . . NumTimePts , NumPaths , K)
SPaths = zeros( NumPaths , NumTimePts ) ;
PVPutPayoff = zeros ( NumPaths , NumTimePts ) ;
PVBS = zeros( NumPaths , NumTimePts ) ;
PVBS2 = zeros( NumPaths , NumTimePts ) ;
rand ( ′state′ , sum ( 100*clock ) ) ;
dt = T / NumTimePts;
nudt = ( r − 0.5 * sigma \hat{ }2 ) * dt ;
sidt = sigma * sqrt ( dt );
% work backwards and generatepresentvalueof
% payoffs and black-scholes  values
  for j = 1 : NumTimePts
t = j * dt;
disc=exp(−r *t ) ;
if  j==1
      SPaths ( : , j ) = S0 * exp ( nudt + sidt randn (NumPaths, 1 ) ) ;
else
    SPaths (: ,j ) = SPaths (: , j − 1) .* exp (nudt + sidt * randn
    (NumPaths , 1 )
); end
PVPutPayoff ( : , j ) = disc * max( 0 , K − SPaths ( : , j ) ) ;
if j < NumTimePts
      [ Call, Put ] = blsprice( SPaths ( : , j ) , K, r , dt , sigma ) ;
      PVBS ( : , j ) = disc*Put;
        if j < NumTimePts−1
              [ Call, Put ] = blsprice( SPaths ( : ,j ) , K, r , 2*dt ,
              sigma ) ;
                PVBS2 ( : , j ) = disc * Put;
            end
          end
        end
end
%%%%%%%%%%%%%%%%%%%%%%%%%%%%%%%%%
function Price = DualProb ( LagrangeMult , CurrentPayoff , . . .
                        Const , LagrangeTerm , LagrangeMultOld)
                  ContVal = Const + LagrangeTerm * LagrangeMult ;
                  Price = mean (max( CurrentPayoff, ContVal ) ) ;
end
%%%%%%%%%%%%%%%%%%%%%%%%%%%%%%%%%%
```

The exemplary disclosed system and method may be used for example in any suitable strategic decision-making (e.g., business decision-making) regarding determining the optimal time of a decision (e.g., of a decision associated with an action). For example, the exemplary disclosed invention may provide a system and method for use with complex mathematical models involving, for example, dynamics and payoffs. For example, the exemplary disclosed system and method may be used in any application involving choosing an optimal time to take an action (e.g., optimal stopping time). For example, the exemplary disclosed system and method may be used for deciding when to exercise an option, deciding when to buy or sell an asset, deciding when to begin or end a project, and/or deciding when to take an action that is tied to a payoff in any suitable situation. For example, the exemplary disclosed system and method may be used in any suitable application involving selecting an optimal time to take an action such as, e.g., financial modeling and decision-making, planning and operations for business associations (e.g., corporate planning), supply chain operations and planning, strategic decision-making (e.g., military, law enforcement, and/or emergency management decision-making involving the optimal commitment of resources at a given time or decision point), and/or machine learning and artificial intelligence applications.

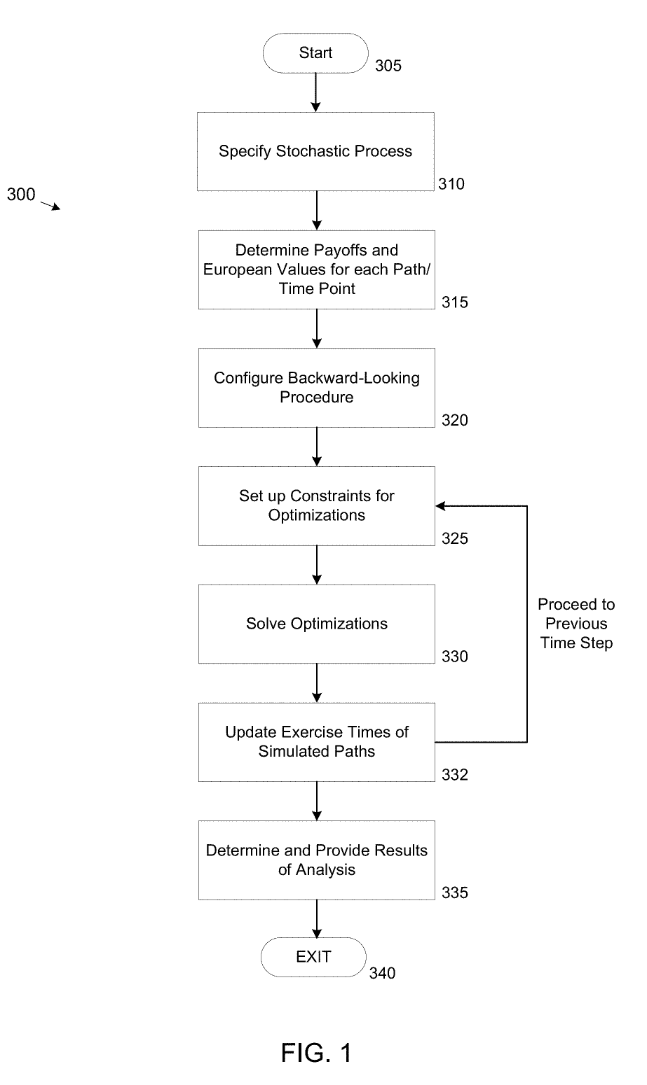

Exemplary processes illustrating the operation of the exemplary system and method will now be disclosed. For example, FIG. 1 illustrates an exemplary process 300 of the exemplary disclosed system and method. For example, process 300 illustrates an exemplary operation of an exemplary embodiment of the exemplary processes and algorithms.

For example, process 300 starts at step 305. At step 310 for example, the exemplary system may provide a stochastic process. For example, the exemplary system may provide processes as illustrated by and described above regarding Equations 1 and 2. At step 315 for example, the exemplary system may determine payoffs and european values for each simulated path of the stochastic process and for each time point as illustrated by and disclosed above regarding Equations 3, 4, and 5 (e.g., including defining an exercise indicator as disclosed above).

At step 320 for example, the exemplary system may configure an exemplary backward-looking procedure (e.g., backward recursion and/or backward induction) as disclosed for example above. For example, the exemplary system may configure portions of a backward-looking procedure as illustrated by and disclosed above regarding Equations 6, 7, 8, 9, and 10.

At step 325 for example, the exemplary system may set up constraints on the analysis as disclosed for example above. For example, the exemplary system may configure and impose an exemplary condition on the backward-looking procedure and/or duality-based procedure as disclosed for example above. For example, the exemplary system may impose that a mean hedging cost remains the same as disclosed, e.g., above.

At step 330 for example, the exemplary system may solve the optimization problems as disclosed, e.g., above. At step 332 for example, the exemplary system may update exercise times of simulated paths as disclosed, e.g., above. The exemplary system may then return to step 325 to repeat portions of the exemplary process (e.g., steps 325, 330, and 332) for any suitable number of iterations based on the optimization problem to be solved.

At step 335 for example, the exemplary system may determine results of the analysis and provide the results to a user. For example, the exemplary system may determine results as illustrated by and disclosed above regarding Equations 17 and 18. The exemplary system may exit at step 340. Also for example, the exemplary system may repeat any suitable number of iterations of process 300 as appropriate for a given application of the exemplary system and method and/or as directed by a user.

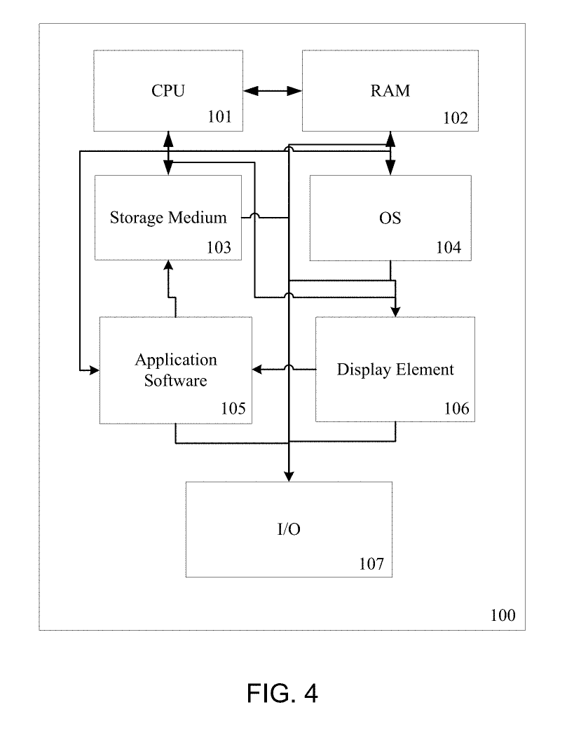

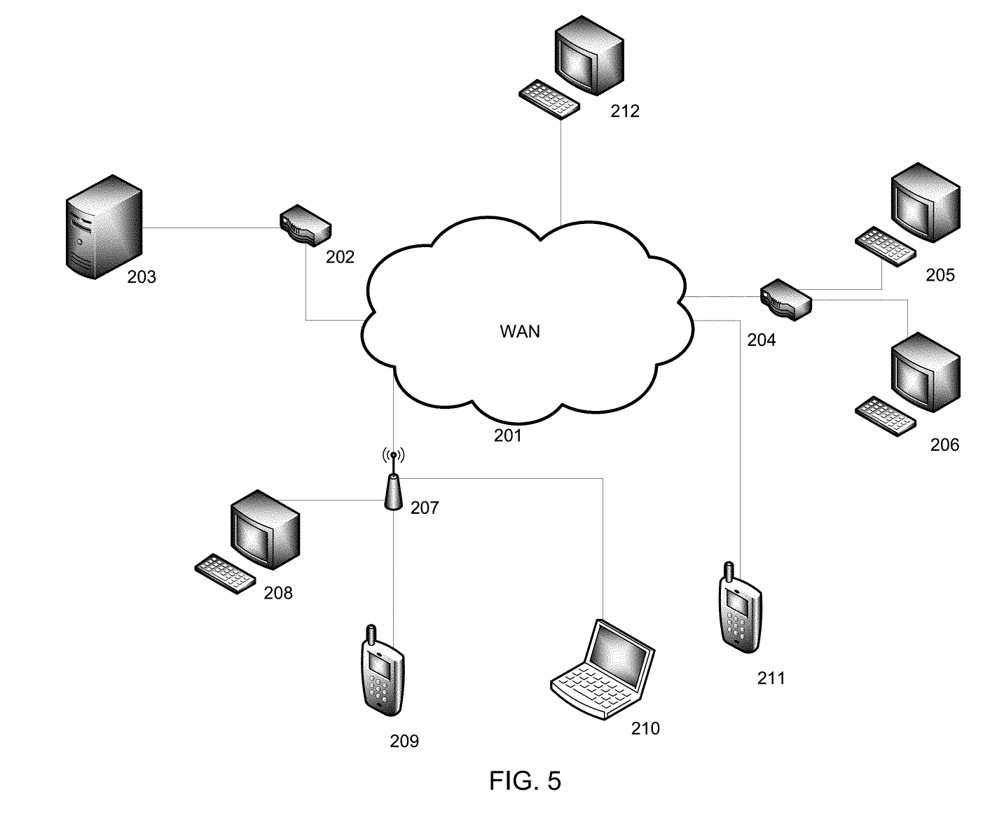

FIGS. 2 and 3 illustrate an exemplary process 400 of an exemplary system 350. For example, exemplary system 350 may include a module 355. For example, module 355 may be an optimal stopping time determination module, comprising computer-executable code stored in non-volatile memory. Module 355 may include components similar to the components disclosed below regarding FIGS. 4 and 5. For example, module 355 may include a processor and any other suitable components of a computing device.

Module 355 may be connected to a WAN 365 (e.g., the internet) that may be similar to WAN 201 described below regarding FIG. 5. Also for example, module 355 may operate from within WAN 365 (e.g., from the cloud) in addition to being connected to WAN 365 (for example, the exemplary optimal stopping time determination module and processor of system 350 may be disposed within (e.g., operate from) WAN 365. A user interface 360 may for example be located with and operate in conjunction with module 355. User interface 355 may alternatively communicate with module 355 via WAN 365. For example, user interfaces 370 and 375 may be connected with module 355 via WAN 365. User interfaces 360, 370, and 375 may be any suitable devices for entering input to and receiving output from module 355 such as, for example, computing devices (e.g. computers, smart phones, tablets) and/or any suitable user interfaces as disclosed below regarding FIGS. 4 and 5. For example, users attempting to take action regarding problems such as optimal stopping problems may utilize system 350 via user interfaces 360, 370, and/or 375.

For example, process 400 may start at step 405. At step 410 for example, a user of the exemplary system (e.g., system 350) may identify criteria and/or parameters associated with an optimal stopping problem. For example, a user may identify a plurality of times for exercising an option, e.g., identifying a plurality of times for exercising a bermudan-style option (for example when the exemplary system and method is a financial system and method for determining optimal times to exercise options regarding securities).

At step 415 for example, a user may enter input into the exemplary system (e.g., system 350) associated with criteria of the problem to be solved (e.g., optimal stopping problem) via an exemplary user interface (e.g., user interfaces 360, 370, and/or 375). For example, the exemplary user interface may include any suitable interface (e.g., graphical user interface) having fields to be completed by a user (e.g., or any other suitable technique for prompting a user for information) for defining a problem to be solved (e.g., optimal solving problem). For example, the exemplary user interface may prompt a user for information based on previous data provided by a user, a type of problem indicated by the user to be solved, and/or input data based on the exemplary processes and algorithms disclosed above. For example, a user may enter input data indicating a type of problem to be solved and/or a field of application of the exemplary system and method (e.g., from a pull-down list in a graphical user interface or any other suitable technique) via the exemplary user interface.

At step 420 for example, the exemplary system may provide output data to a user via an exemplary user interface, indicating results of exemplary processes and algorithms to the user for solving a given problem (e.g., the system may provide results based on calculations and determined according to exemplary process 300). For example, the exemplary output may include results indicating an optimal time to exercise an option based on parameters and input describing a given problem to be solved (e.g., as disclosed above).

At step 425 for example, a user may take an optimal stopping time action based on the output provided at step 420. The user may then exit process 400 at step 430. For example when the exemplary system and method is a financial system and method for determining an optimal time to exercise an option (e.g., a securities activity such as a sale of stock), a user may take an action such as selling stock at an optimal time at step 425 based on the output provided by the exemplary system at step 420. For example, the user may operate an exemplary user interface (e.g., user interface 360, 370, and/or 375) as part of an enterprise engaged in buying and selling securities. The user may enter input and receive output via the exemplary user interface as disclosed for example above to optimize taking actions at step 425 based on an operation of the exemplary disclosed system and method.

Several advantages may be associated with the exemplary disclosed system and method. The exemplary disclosed system and method may for example provide a technique for solving problems in a high-dimensional setting while providing suitable hedging of risk. For example, the exemplary disclosed system and method may provide and accurate and precise technique for solving optimal stopping problems. Also for example, the exemplary disclosed system and method may provide a technique for avoiding problems such as the “curse of dimensionality” while providing an unbiased estimator of a parameter being estimated.

An illustrative representation of a computing device appropriate for use with embodiments of the system of the present disclosure is shown in FIG. 4. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 5, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 5, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 5, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

What is claimed is:

1. A system for determining an optimal stopping time, comprising:
an optimal stopping time determination module, comprising computer-executable code stored in non-volatile memory;
a processor; and
a user interface;
wherein the optimal stopping time determination module, the processor, and the user interface are configured to:
solve an optimal stopping problem using a backward-looking procedure; and
prescribe a hedge as part of solving the optimal stopping problem using the backward-looking procedure.

2. The system of claim 1, wherein prescribing the hedge includes imposing zero mean profit or loss for each hedging strategy.

3. The system of claim 1, wherein using the backward-looking procedure includes using a backwards recursion.

4. The system of claim 1, wherein solving the optimal stopping problem using the backward-looking procedure includes rolling over a one-step european, a two-step european, and a two-step bermudan.

5. The system of claim 1, wherein the one-step european, the two-step european, and the two-step bermudan are rolled over at each of a plurality of time steps.

6. The system of claim 1, wherein solving the optimal stopping problem includes stopping, in which stopping is selected from the group consisting of buying an asset, selling an asset, starting or ending an activity, and starting or ending a project.

7. The system of claim 1, wherein solving the optimal stopping problem using the backward-looking procedure includes using a stochastic simulation of a plurality of variables over a predetermined number of discrete time steps.

8. The system of claim 7, wherein solving the optimal stopping problem using the backward-looking procedure includes determining the optimal stopping time for simulated paths of the stochastic simulation with increasing numbers of remaining time steps.

9. A method for determining an optimal stopping time, comprising:
providing a stochastic simulation of a plurality of variables over a predetermined number of time steps of each simulated path of the stochastic simulation;
solving optimal stopping problems using backwards recursion over a plurality of simulated paths; and
imposing constraints on two objective functions, resulting in constrained optimization problems solved at each stage in backward recursion.

10. The method of claim 9, wherein solving optimal stopping problems includes solving sub-problems with an increasing number of time steps in succession.

11. The method of claim 9, wherein an option price and exercise times for all simulated paths are output to a user interface.

12. The method of claim 9, wherein imposing constraints on the two optimization problems solved at each stage in the backward recursion includes imposing three constraints that impose that no excess profit or loss is realized by hedging by a seller.

13. A method for determining an optimal stopping time, comprising:
solving optimal stopping problems for simulated paths using backward recursion to determine stopping times for each simulated path; and
prescribing a hedge as part of solving the optimal stopping problems using backward recursion;
wherein solving the optimal stopping problems using backward recursion includes imposing constraints on each of two objective functions in each step of the backward recursion.

14. The system of claim 13, wherein prescribing the hedge includes imposing equality in the mean hedging cost of the three hedging strategies.
